(19) United States
(12) Patent Application Publication
(10) Pub. No.: US 2006/0160955 A1
(43) Pub. Date: Jul. 20, 2006

(54) Method for inhibiting agglomeration of block copolymers

(75) Inventors: Peter W. Boerner, Massillon, OH (US); Daniel F. Graves, Canal Fulton, OH (US)

Correspondence Address: Chief IP Counsel;BRIDGESTONE AMERICAS HOLDING, INC., 1200 Firestone Parkway, Akron, OH, 44317, US

(73) Assignee: Firestone Polymers, LLC

(21) Appl. No.: 11/329,622

(22) Filed: Jan. 11, 2006

Related U.S. Application Data
(60) Provisional application No. 60/644,194, filed on Jan. 14, 2005.

(51) Int. Cl. C08F 297/02

(52) U.S. Cl. 525/242

(57) ABSTRACT

A method for inhibiting agglomeration of a block copolymer is presented, the method including coupling a plurality of block copolymer segments with a degradable coupling agent and thereafter drying the coupled block copolymer.

This application references Provisional Application No. 60/644,194 filed on Jan. 14, 2005. The entire disclosure of this referenced provisional application is hereby incorporated by reference.

### BACKGROUND OF THE INVENTION

1. Field of the Invention

The present invention relates to a method for inhibiting the agglomeration of block copolymers prior to use, by reversibly coupling the block copolymers with a degradable coupling agent. More particularly, the invention relates to a method for preparing block copolymers for storage, transport and/or use, by inhibiting the agglomeration often experienced during storage and transport of block copolymers and eliminating the need to de-agglomerate the copolymers prior to use.

2. Technical Background

The production and transport of block copolymers in a form useable in a commercial process has in the past provided difficulties. Block copolymers are often dried into pellet, crumb, or bale form for transport and use in manufacturing processes. Transport may be to a site that is any site other than the site of the coupling, such as the site of a manufacturing process. In one application, because certain block copolymers often have a waxy characteristic, the pellets or crumbs can agglomerate together into hard lumps during transport. These hard lumps usually cannot be used in the end process without further processing, and have to be broken down. This adds extra steps to the manufacturing process and reduces efficiency and adds cost. In another application, certain block copolymers may have a liquid characteristic, whereas block copolymers with a non-liquid characteristic are desired for advantages in transportation.

For instance, block copolymers, such as styrene-butadiene block copolymers, are often used in the manufacture of asphalt; however, asphalt manufacturers do not want to have to break up agglomerated copolymers, or often do not have the equipment to break up agglomerated polymers prior to their use in the manufacturing process. Further, the agglomerated polymers do not dissolve as readily during the manufacturing process.

Preparation of linear block copolymers of vinyl aromatic hydrocarbons and conjugated dienes, such as styrene and butadiene, is well known. One of the first patents directed toward linear block copolymers made with styrene and butadiene is U.S. Pat. No. 3,149,182. Several other variations for block copolymer structures and methods of preparation have been found since then.

One method for producing a number of commercially important thermoplastic elastomers such as styrene-butadiene block copolymers, is by anionic polymerization. There have been generally three different types of copolymers produced by anionic polymerization styrene-butadiene copolymers: tapered block, di/tri-block and random. Those most useful in the instant invention are diblock copolymers.

Tapered or graded block styrene-butadiene copolymers are typically formed when alkyllithium catalysts, styrene and butadiene are mixed in a batch reactor. Random styrene-butadiene copolymers are typically formed when the anionic polymerization is carried out in continuous reactor.

Di-block or tri-block styrene-butadiene copolymers are typically formed when the polymerization is carried out in a semi-batch reactor by sequential addition of monomers. Because of the stability of the “living” nature of the allylic lithium end group, butadiene-styrene copolymers of widely different structures and properties can be prepared.

For example, in styrene-butadiene-styrene (S-B-S) tri-block copolymers, the rubbery soft B block is between the two hard S blocks. The arrangement of hard and soft blocks yields commercially useful properties. These copolymers have two phases, two glass transition temperatures and are characterized by high raw strength, complete solubility and reversible thermoplasticity. S-B-S tri-block copolymers are produced by first polymerizing styrene to form the S block followed by polymerizing the butadiene to form the half of the B block. Then a di-functional coupling agent is added to link the living polymer chains through the B blocks to make the B block twice as long and form the tri-block polymer.

Thermoplastic elastomers made of multi-block styrene-butadiene copolymers have been also developed. One of the types of block copolymers that have utility are tri-block copolymers having a block arrangement of B-S-S-B, where the S block is a styrene block and the B block is a butadiene block. One commercialized example is Stereon® 210, which is a di-block copolymer composition formed from tapered S-B di-blocks. Stereon® 210 contains approximately 10% of thermally coupled block arrangements of B-S-S-B and has a vinyl content of less than 10 percent by weight. The Stereon® 210 copolymer has a tensile strength of 20 p.s.i. or less.

Handlin, in U.S. Patent Application Pub. No. 2003/0187137, discloses a linear hydrogenated tetra-block copolymers consisting of four alternating blocks having the block arrangement of S₁-B₁-S₂-B₂ wherein: the two polymer blocks B₁ and B₂ are hydrogenated butadiene monomers in which at least 90% of the olefinically unsaturated double bonds contained in the unhydrogenated polymer block are hydrogenated; and the two polymer blocks S₁ and S₂ comprise a mono-alkenyl arene monomer, such as styrene monomer. These tetra-block copolymers have tensile strengths of between 2,000 p.s.i. and 3,000 p.s.i.

However, as noted above, when block copolymers such as described are formed and then dried for storage and/or transport, their waxy characteristics can cause agglomeration of the copolymer pellets or crumbs during storage or transport. This requires further processing before the copolymers can be effectively used in a manufacturing process, like the preparation of asphalt or adhesives. In addition, the agglomerated copolymer pellets or crumbs exhibit inferior dissolving and blending characteristics.

### SUMMARY OF THE INVENTION

The present invention provides a storable/transportable block copolymer which does not require further processing to de-agglomerate the copolymer prior to use in a manufacturing process. More specifically, the present invention provides a block copolymer which resists the agglomeration commonly observed after storage or transport of the copolymer, which would otherwise require one or more additional processing steps prior to inclusion in the target manufacturing process.

The inventive copolymer comprises a reversibly coupled block copolymer, wherein the coupling agent degrades under the conditions at which the target manufacturing process is performed. The invention also includes a process for preparing the inventive coupled block copolymer. For example, for a process such as the production of asphalt, which is performed at temperatures in excess of about 300° F., the coupling agent employed can be a thermally degradable coupling agent that degrades at temperatures of as low as about 300° F. In this way, the coupling agent provides for a copolymer which resists agglomeration during storage and/or transport, and yet which “automatically” decouples during the asphalt processing, without any need for further pre-processing prior to use in the asphalt manufacturing process. Such, pre-processing steps may include grinding, etc. in one example.

More particularly, the invention includes a method for inhibiting agglomeration of a block copolymer, such as a diblock copolymer, comprising coupling a plurality of block copolymer segments with a degradable coupling agent, such as a thermally degradable coupling agent, resulting in a coupled block copolymer, and thereafter drying the coupled block copolymer. Where the manufacturing process in which the copolymer is to be used is a relatively high temperature process, such as for the production of asphalt, the degradable coupling agent can be one which thermally degrades at temperatures of at least about 300° F.

The inventive method provides for preparing a coupled block copolymer for use in a manufacturing process, including the steps of coupling a plurality of block copolymer segments with a degradable coupling agent to form a coupled block copolymer; and subjecting the coupled block copolymer to conditions under which the coupling agent degrades. Most advantageously, the coupling agent degrades under the conditions of use in the manufacturing process.

### DETAILED DESCRIPTION OF THE INVENTION

The block copolymer useful in the present invention may be produced using any process without particular restriction. For example, the block copolymer may be produced using anionic polymerization techniques. For instance, a styrene-butadiene block copolymer can easily be obtained in accordance with the following process.

In a hydrocarbon solvent, styrene and butadiene are copolymerized in the presence of (1) an organolithium initiator, and (2) a vinyl modifier. After copolymerization has been completed, a reversible coupling agent in accordance with the invention is added to the obtained copolymer as the coupling agent to obtain the reversibly coupled styrene-butadiene copolymer of the present invention.

Examples of the hydrocarbon solvent used in the present invention include aromatic hydrocarbon solvents, such as benzene, toluene, and xylene; aliphatic hydrocarbon solvents, such as n-pentane, n-hexane, and n-butane; alicyclic hydrocarbon solvents, such as methylcyclopentane and cyclohexane; and mixture of these solvents. The invention is not limited by the hydrocarbon solvent used.

Examples of the organolithium initiator used in the present invention include alkyllithiums and alkyldilithiums, such as methyllithium, ethyllithium, propyllithium, n-butyllithium, sec-butyllithium, t-butyllithium, hexyllithium, octyllithium, tetramethylenedilithium, pentamethylenedilithium, and hexamethylenedilithium; aryllithiums and aryldilithiums, such as phenyllithium, tolyllithium, and lithium naphthylide; and aralkyllithiums and aralkyldilithiums, such as benzyllithium and dilithium formed by the reaction of diisopropenylbenzene and butyllithium. Among these organolithium initiators, n-butyllithium and sec-butyllithium are preferable in view of the industrial applicability. A single type or a mixture of two or more types of the organolithium initiator can be used. The amount of the organolithium initiator used in the polymerization may vary depending on the desired molecular weight of the obtained copolymer. The amount is generally 0.05 to 15 mmol, preferably 0.1 to 10 mmol, per 100 g of the monomer.

In one embodiment, to control vinyl content within the elastomeric block, a vinyl modifier may be added to the polymerization ingredients. Amounts range between 0 and 90 or more equivalents per equivalent of lithium. The amount depends on the amount of vinyl desired, the level of styrene employed and the temperature of the polymerization, as well as the nature of the specific vinyl modifier (modifier) employed. Suitable polymerization modifiers include, for example, ethers or amines to provide the desired microstructure and randomization of the comonomer units. In one embodiment, about 30% of the polymer chains have an amine.

An example of compounds useful as vinyl modifiers include those having an oxygen or nitrogen heteroatom and a non-bonded pair of electrons. Examples include dialkyl ethers of mono and oligo alkylene glycols; “crown” ethers; tertiary amines such as tetramethylethylene diamine (TMEDA); linear THF oligomers; and the like. Specific examples of compounds useful as vinyl modifiers include tetrahydrofuran (THF), linear and cyclic oligomeric oxolanyl alkanes such as 2,2-bis(2′-tetrahydrofuryl)propane, di-piperidyl ethane, dipiperidyl methane, hexamethylphosphoramide, N-N′-dimethylpiperazine, diazabicyclooctane, dimethyl ether, diethyl ether, tributylamine and the like. The linear and cyclic oligomeric oxolanyl alkane modifiers (OOPs) are described in U.S. Pat. No. 4,429,091, incorporated herein by reference.

In one particular embodiment of the invention, the synthesis of diene with aromatic hydrocarbon, particularly synthesis of a polybutadiene block by way of polymerizing 1,3-butadiene, preferably occurs in the presence of a vinyl modifier. While certain modifiers may randomize the copolymer when employed in particular amounts, in one embodiment the amount of vinyl modifier that is used is insufficient to randomize the copolymer. Useful vinyl modifiers include OOPs. Those skilled in the art will be able to readily select the amount of vinyl modifier that will be useful in achieving the desired properties set forth above. For example, when a OOPs vinyl modifier is employed, the amount present within the polymerization is generally from about 0.001 to about 1.0 and based upon the amount of lithium charged into the reactor.

Anionically polymerized living polymers can be prepared by either batch or continuous methods. A batch polymerization is preferably begun by charging monomer and solvent to a suitable reaction vessel, followed by the addition of the vinyl modifier (if employed) and an initiator compound. The reactants are preferably heated to a temperature of from about 20 to about 130° C. and the polymerization is allowed to proceed for from about 0.1 to about 24 hours. This reaction preferably produces a reactive polymer having a reactive or living end. Preferably, at least about 30% of the polymer molecules contain a living end. More preferably, at least about 50% of the polymer molecules contain a living end. Even more preferably, at least about 80% contain a living end.

In one embodiment, a potassium compound is used as a modifier to produce microblocks. In another particular embodiment, the potassium compound is a styrene block modifier producing microblocks of the styrene monomer.

In the present invention, an ether compound and/or an amine compound may be used in combination with the potassium compound. As the ether compound and the amine compound, compounds generally used as the randomizer in the copolymerization of styrene and butadiene can be used and are not particularly limited. Particularly, dialkoxyalkyl compounds, such as diethoxyethane; diethylene glycol dialkyl ether compounds, such as diethylene glycol dimethyl ether and diethylene glycol diethyl ether; ethylene glycol dialkyl ether compounds, such as ethylene glycol dimethyl ether and ethylene glycol diethyl ether; tetrahydrofuran oligomer compounds, such as ditetrahydrofurylpropane; tetrahydrofuran; diamine compounds, such as tetramethylethylenediamine; and triamine compounds, such as pentamethylenediethylenetriamine, are advantageously used.

The ether compound or the amine compound is used in the copolymerization preferably in such an amount that the content of the vinyl unit in the obtained copolymer in the butadiene part is 30% by mol or less. The amount of the ether compound or the amine compound is different depending on the type of the ether compound or the amine compound and cannot be specified. An amount of 0.01 to 2.0 mol equivalent per 1 mol of lithium is generally used. For example, when tetrahydrofuran is used, an amount of 0.5 to 2.0 mol equivalent is preferable. When diethylene glycol dimethyl ether is used, an amount of 0.03 to 0.1 mol equivalent is preferable.

Various elements of the molecular structure of the block copolymer of the present invention, such as the number of units of styrene in a sequence in a block, the content of a block consisting of units of styrene in a sequence based on the total units of styrene, the content of the total styrene units in the block copolymer, the molecular weight of the block copolymer, and the content of the vinyl structure in the butadiene part, when a styrene/butadiene block copolymer is taken as an example, can be controlled according to chemical engineering by suitably selecting the conditions of the preparation, such as the ratio of the monomers, the amounts of the monomers used in the individual steps, the interval between the addition of a monomer in one step and the addition of the other monomer in the next step, the conversion of a monomer achieved in one step when the other monomer is added in the next step, the number of separate additions of the monomers, the amount of the organolithium initiator, and the type and the amount of the modifier. Accordingly, a desired block copolymer can be obtained easily.

In order to form the reversibly coupled block copolymer of the invention, the block copolymer, for instance one as formed as described above, is coupled with a degradable coupling agent. This coupled block copolymer can be obtained by coupling the live lithium at the end of the molecule of the block copolymer with the degradable coupling agent. The degradable coupling agent should be selected such that it degrades under conditions existing in the target manufacturing process. For example, if the target manufacturing process is one for the production of asphalt, the coupling agent should degrade under asphalt production conditions. Most advantageously, the coupling agent should be thermally degradable, so as to degrade at the normal processing temperature at which the target manufacturing process is conducted (for example, temperatures in excess of 300° F. in an asphalt production process).

Suitable degradable coupling agents depend on the particular conditions or characteristics of the target manufacturing process for which the reversibly coupled block copolymer is intended, and can include at least one compound selected from the group consisting of tin compounds having a plurality of halogen atoms, silicon compounds having a plurality of halogen atoms, silicon compounds having a plurality of alkoxy groups, polyepoxy compounds, polyhalogenated hydrocarbons, esters of polycarboxylic acids, anhydrides of polyacids, polyisocyanates, polyaldehydes, polyketones, and polyvinyl compounds. Examples of the halogen compound of tin include tin halides, such as tin tetrachloride and the like, and organotin halides, such as dibutyldichlorotin, diphenyldichlorotin, triphenyltin chloride, and the like. Examples of the halogen compound of silicon include silicon tetrachloride, trichlorotriethylenesilane, and the like. The halogen compound of tin or the halogen compound of silicon is used in such an amount that one atom of the halogen in the halogen compound is present per one equivalent of the metal, such as lithium, at the live end of the block copolymer.

In a preferred embodiment, the block copolymer segments include at least one of a styrene block, a butadiene block and mixtures thereof, and the coupling agent is a tin compound.

In one embodiment, the block copolymer has a number average molecular weight before coupling preferably between 50,000 and 90,000, and more preferably between 60,000 and 80,000.

Depending on the target manufacturing process, an alkoxysilane compound may be used in place of the halogen compound of tin or the halogen compound of silicon. Examples of suitable alkoxysilane compounds include tetraalkoxysilane compounds, such as tetramethoxysilane, and the like; tetraaryloxysilane compounds, such as tetraphenoxysilane, and the like; alkylalkoxysilane compounds having 2 or more alkoxy groups, such as methyltriethoxysilane and the like; alkylaryloxysilane compounds having 2 or more aryloxy groups, such as methyltriphenoxysilane, and the like; alkenylalkoxysilane compounds having 2 or more alkoxy groups, such as vinyltrimethoxysilane, and the like; and halogenoalkoxysilane compounds, such as trimethoxy-chlorosilane, and the like. When an alkoxysilane compound is used, it is preferred that the resultant block copolymer contains at least one alkoxysilano group.

In the coupling reaction, one equivalent of the metal, such as lithium, at the live end of the molecule of the block copolymer reacts with one equivalent of each alkoxy group in the alkoxysilane compound. Therefore, in order to prepare a block copolymer containing at least one alkoxysilano group, the amount of the alkoxysilane compound used is selected such that one alkoxy group in the alkoxysilane compound is reserved as the group to be incorporated into the block copolymer, and one equivalent of at least one of the remaining alkoxy groups is present per one equivalent of lithium at the live end of the molecule of the block copolymer. Because one alkoxy group in the alkoxysilane compound must be reserved as the group to be incorporated into the block copolymer, the alkoxysilane compounds described above (including alkoxysilane compounds containing two or more alkoxy groups) are used. When a halogenoalkoxysilane compound is used, one equivalent of the metal, such as lithium, at the live end of the block copolymer reacts with one equivalent of the halogen and with each of the alkoxy groups. Therefore, the amount of the halogenoalkoxysilane compound used for incorporating at least one alkoxy group into the block copolymer can be easily determined in a manner similar to that described above.

The invention also includes a method of making a block copolymer comprising forming a plurality of block copolymer segments; coupling at least two of the block copolymer segments with a coupling agent thereby forming a coupled block copolymer, wherein the coupling agent thermally degrades at temperatures of 300° F. or higher; and drying the coupled block copolymer into a crumb or pellet form.

In one particular embodiment, the polymer is a liquid. Coupling the polymer produces a more viscous liquid, or even a solid. The coupled polymer may then be processed into pellet or crumb form. The pellet or crumb form of the coupled polymer may then be more easily handled, shipped, and used. Further, manufacturing processes that use crumb units or drum driers may then be used to process the coupled polymer, whereas the uncoupled liquid polymer may need a separate manufacturing process.

The reversibly coupled block copolymers of the present invention are useful in hot-melt adhesives. Hot-melt adhesives may have a processing temperature of at least about 300° F., and typically have processing temperatures of about 350° F.

Where the target manufacturing process is one for the production of asphalt, the inventive method includes forming a plurality of block copolymer segments; coupling at least two of the block copolymer segments with a coupling agent thereby forming a coupled block copolymer, wherein the coupling agent thermally degrades at temperatures of 300° F. or higher; drying the coupled block copolymer into a crumb or pellet form; and adding the coupled block copolymer into a batch for making asphalt.

As noted, an advantageous use of the reversibly coupled block copolymers of the present invention is in the production of asphalt. That is, styrene-butadiene block copolymers are often employed in the production of asphalt. A reversibly coupled styrene-butadiene block copolymer which resists agglomeration during storage and/or transport would be particularly beneficial to makers of asphalt, since such a reversibly coupled copolymer would eliminate the need to de-agglomerate (e.g. grinding) the copolymer before inclusion in the asphalt production process, yet still be usable in the process since the coupling agent degrades at, e.g., asphalt production process temperatures.

Virtually all asphalts used in the United States are products of the distillation of crude petroleum. Chemically, asphalts are complex aggregations of rather large aliphatic and cyclic hydrocarbon molecules. Besides the obvious hydrocarbon content, additional constituents in asphalts may include oxygen, sulfur, and nitrogen (often in substantial quantities) and iron, nickel, and vanadium (present usually in trace quantities). Asphaltic mixtures composed of mineral aggregate and bituminous constituents are used widely in the road construction industry.

Asphalt is produced in a variety of types and grades ranging from hard and brittle solids to almost water-thin liquids. Asphalt cement is the basis of all of these products. It can be made fluid for construction uses by heating, by adding a solvent, or by emulsifying it. Hot mix asphalts are used extensively on main highway construction where greater durability is required. When a petroleum solvent, such as naphtha or kerosene, is added to the base asphalt to make it fluid, the product is called a cutback. When asphalt is broken into minute particles and dispersed in water with an emulsifier, it becomes an asphalt emulsion. The tiny droplets of asphalt remain uniformly suspended until the emulsion is used for its intended purpose. When combined with an appropriate hydrocarbon solvent, the asphalt cement in a cutback is in solution. In an emulsion, the chemical emulsifier is oriented in and around droplets of asphalt cement, thus influencing their dispersion and stable suspension in water. When either a cutback or an emulsion is used in the field, evaporation of the asphalt carrier (i.e., the cutback hydrocarbon solvent or the emulsion water) causes the cutback or emulsion to revert to asphalt cement. In the case of the emulsion, the chemical emulsifier is retained with the deposited asphalt. Because environmental considerations militate against the use of cutback asphalts, due to the necessary solvent expulsion from these applied asphaltic compositions, asphalt emulsions are greatly preferred.

In any event, inclusion of the inventive reversibly coupled block copolymer of the present invention in an asphalt production process eliminates a processing step, the copolymer de-agglomeration step that has been found to be undesirable, for example, breaking up the bale or grinding of agglomerated copolymer. By the elimination of this undesirable step, the inclusion of block copolymers in asphalt production process can be performed more efficiently and with substantial cost savings.

All cited patents, patent applications and publications referred to in this application are incorporated by reference.

The invention thus being described, it will be obvious that it may be varied in many ways. Such variations are not to be regarded as a departure from the spirit and scope of the present invention and all such modifications as would be obvious to one skilled in the art are intended to be included within the scope of the following claims.

What is claimed is:

1. A method for inhibiting agglomeration of a block copolymer comprising coupling a plurality of block copolymer segments with a degradable coupling agent and thereafter drying the coupled block copolymer.

2. The method of claim 1 wherein the degradable coupling agent comprises thermally degradable.

3. The method of claim 2 wherein the degradable coupling agent thermally degrades at temperatures of at least about 300° F.

4. The method of claim 3 wherein the degradable coupling agent thermally degrades at temperatures of at least about 325° F.

5. The method of claim 4 wherein the degradable coupling agent thermally degrades at temperatures of at least about 350° F.

6. The method of claim 2 wherein the degradable coupling agent comprises a tin compound.

7. The method of claim 1 wherein at least one block copolymer segment comprises a diblock.

8. The method of claim 7 wherein the block copolymer segments comprise at least one of a styrene block, a butadiene block and mixtures thereof.

9. The method of claim 1 wherein the block copolymer comprises a hot-melt adhesive.

10. The method of claim 1, wherein the method further comprises transferring the coupled block copolymer to a site of a manufacturing process.

11. A method for preparing a block copolymer for transport, comprising coupling a plurality of block copolymer segments with a degradable coupling agent and thereafter drying the coupled block copolymer.

12. The method of claim 11 wherein the degradable coupling agent comprises thermally degradable.

13. The method of claim 12 wherein the degradable coupling agent thermally degrades at temperatures of at least about 300° F.

14. The method of claim 12 wherein the degradable coupling agent comprises a tin compound.

15. The method of claim 11 wherein at least one block copolymer segment comprises a diblock.

16. The method of claim 15 wherein the block copolymer segments comprise at least one of a styrene block, a butadiene block and mixtures thereof.

17. A method for preparing a coupled block copolymer for use in a target manufacturing process, comprising:
coupling a plurality of block copolymer segments with a degradable coupling agent to form a coupled block copolymer;
subjecting the coupled block copolymer to conditions under which the coupling agent degrades.

18. The method of claim 17 wherein the degradable coupling agent comprises thermally degradable.

19. The method of claim 18 wherein the degradable coupling agent thermally degrades at temperatures of at least about 300° F.

20. The method of claim 18 wherein the degradable coupling agent comprises a tin compound.

21. The method of claim 17 wherein at least one block copolymer segment comprises a diblock.

22. The method of claim 21 wherein the block copolymer segments comprise at least one of a styrene block, a butadiene block and mixtures thereof.

23. The method of claim 17 wherein the coupling agent degrades under the conditions of use in the target manufacturing process.

24. A method of making a block copolymer comprising:
forming a plurality of block copolymer segments;
coupling at least two of the block copolymer segments with a coupling agent thereby forming a coupled block copolymer, wherein the coupling agent thermally degrades at temperatures of 300° F. or higher; and
drying the coupled block copolymer into a crumb or pellet form.

25. The method of claim 24 wherein the degradable coupling agent comprises a tin compound.

26. The method of claim 24 wherein at least one block copolymer segment comprises a diblock.

27. The method of claim 26 wherein the block copolymer segments comprise at least one of a styrene block, a butadiene block and mixtures thereof.

28. A method of making an asphalt comprising:
forming a plurality of block copolymer segments;
coupling at least two of the block copolymer segments with a coupling agent thereby forming a coupled block copolymer, wherein the coupling agent thermally degrades at temperatures of 300° F. or higher;
drying the coupled block copolymer; and
adding the coupled block copolymer into a batch for making asphalt.

29. The method of claim 28 wherein the degradable coupling agent comprises a tin compound.

30. The method of claim 28 wherein at least one block copolymer segment comprises a diblock.

31. The method of claim 30 wherein the block copolymer segments comprise at least one of a styrene block, a butadiene block and mixtures thereof.

32. The method of claim 28, wherein the method further comprises transferring of the coupled block copolymer to a site for manufacturing the asphalt.
